(19) United States
(12) Patent Application Publication
(10) Pub. No.: US 2026/0043608 A1
(43) Pub. Date: Feb. 12, 2026

(54) METHODS AND APPARATUS FOR EQUIPMENT BAG AIR CIRCULATION DEVICE

(71) Applicant: Justin A. Tinnes, Billings, MT (US)

(72) Inventor: Justin A. Tinnes, Billings, MT (US)

(21) Appl. No.: 19/273,611

(22) Filed: Jul. 18, 2025

Related U.S. Application Data
(60) Provisional application No. 63/681,592, filed on Aug. 9, 2024.

(51) Int. Cl. F26B 9/00

(52) U.S. Cl. CPC F26B 9/003

(57) ABSTRACT

Methods and apparatus for an equipment bag air circulation device according to various aspects of the present technology comprise an insertable body configured to be placed inside of an equipment bag to facilitate the drying of equipment after use without having to remove the equipment from the bag. The body has a flat base with a set of openings for allowing air to flow outward from an inner volume of the base. A set of dividers may be selectively connected to an upward facing surface of the base to create two or more compartments within the equipment bag sized to hold pieces of equipment. The body may also comprise an air coupler configured to be connected to an air source to direct a flow of air into the inner volume of the base.

### BACKGROUND OF TECHNOLOGY

Equipment (gear) bags come in various shapes and sizes and are used in many sports such as hockey, baseball/softball, lacrosse, and football to allow players an easy way to carry and transport equipment. Equipment such as helmets, gloves, and footwear are commonly stored inside of the bag between use. Since equipment is placed into the gear bag immediately after use, it is not uncommon for at least some of the equipment to be damp from an athlete's perspiration or from direct exposure to environmental conditions. Equipment stored inside of the gear bag may not completely dry or air out due to a lack of circulation of air through a closed gear bag. The damp conditions create an environment in which the equipment may take on odors as a result of bacterial growth.

### SUMMARY OF THE TECHNOLOGY

Methods and apparatus for an equipment bag air circulation device according to various aspects of the present technology comprise an insertable body configured to be placed inside of an equipment bag to facilitate the drying of equipment after use without having to remove the equipment from the bag. The body has a flat base with a set of openings for allowing air to flow outward from an inner volume of the base. A set of dividers may be selectively connected to an upward facing surface of the base to create two or more compartments within the equipment bag sized to hold pieces of equipment. The body may also comprise an air coupler configured to be connected to an air source to direct a flow of air into the inner volume of the base.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1 representatively illustrates an air circulation device in accordance with an exemplary embodiment of the present technology;

FIG. 2 representatively illustrates the air circulation device positioned within a gear bag in accordance with an exemplary embodiment of the present technology;

FIG. 3 representatively illustrates a top view schematic of the air circulation device with equipment located in discrete sections in accordance with an exemplary embodiment of the present technology;

FIG. 4 representatively illustrates a cross-sectional view across line A-A of the air circulation device shown in FIG. 3 in accordance with an exemplary embodiment of the present technology;

FIG. 5 representatively illustrates a cross-sectional view across line B-B of the air circulation device shown in FIG. 3 in accordance with an exemplary embodiment of the present technology; and

FIG. 6 representatively illustrates a perspective view of a coupling for connecting an air blower to the air circulation device in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of materials, couplings, air nozzles, and filters. In addition, the present technology may be practiced in conjunction with any number of equipment bags or other storage containers, and the system described is merely one exemplary application for the technology. Methods and apparatus for an air circulation device for an equipment bag according to various aspects of the present technology may operate in conjunction with any suitable air flow generators such as a forced air drying machine, vacuum, and other air moving equipment.

The present technology describes a system that directs a pressurized air flow into an equipment bag to facilitate the drying of wet equipment without having to remove the equipment from the bag. A feature of the technology is that it allows for equipment such as sporting equipment, work gear, and other items that are often transported in a bag that are subject to getting wet or damp during use to be positioned within the equipment bag and left in place to dry. There is no need to adjust the gear or take it out of the equipment bag for it to dried. In one representative embodiment, once a player is done playing a sport and sheds their gear, which may be damp from perspiration, the player only has to place their gear into their existing gear bag. The air circulation device is configured to be prepositioned within the gear bag so that it can receive the gear. Once the gear is positioned in the bag, the player may connect an air dryer blower unit to air circulation device and turn the dryer on. The air circulation device will then direct the airflow throughout the gear bag to dry the equipment. After a period of time, the equipment is dry and ready for use.

Another feature of the technology is that warm air may be used to not only dry the equipment but also keep it warm. For example, during winter, in cold climates, or in sporting arenas such as ice rinks, the ambient temperature may be significantly below standard room temperature of between about 68° F. to about 78° F. (20° C. to 26° C.). Sporting gear left in these conditions may feel cold when worn. If the air dryer blower unit is configured to also provide heated air, then not only may the gear be dry, but it may also be warm.

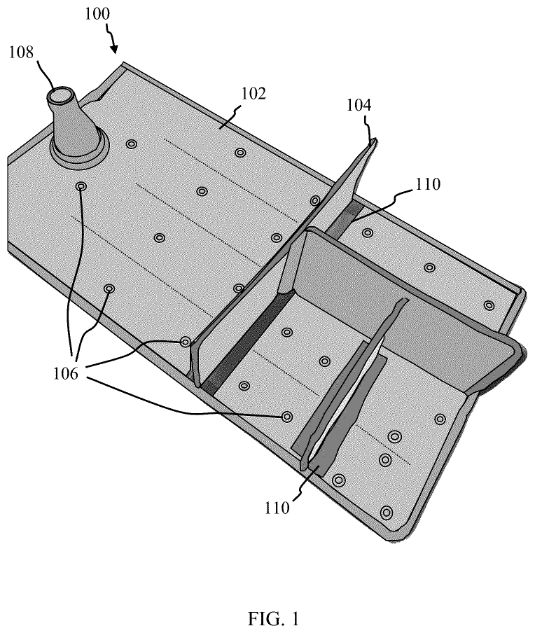

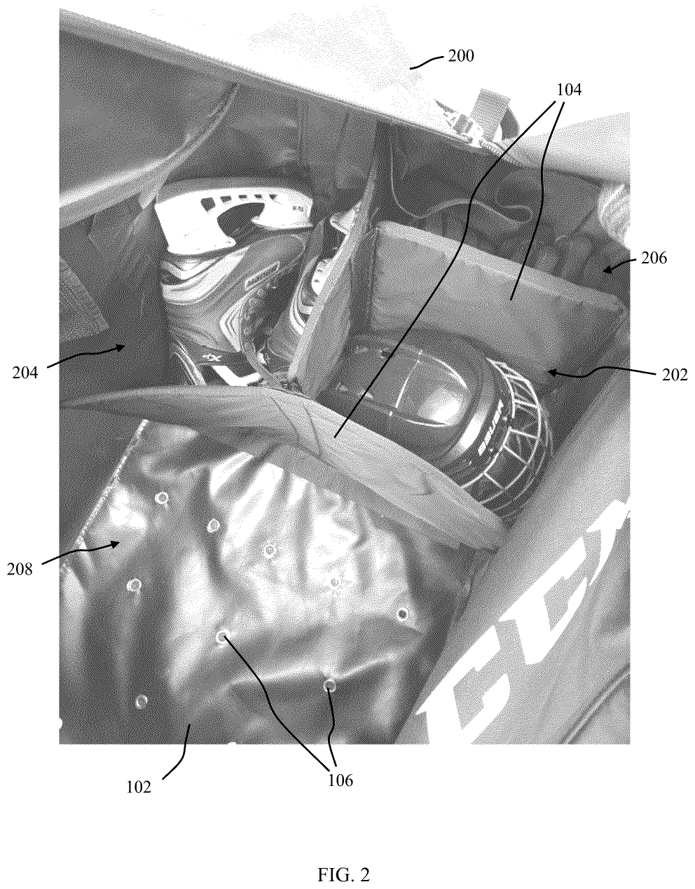

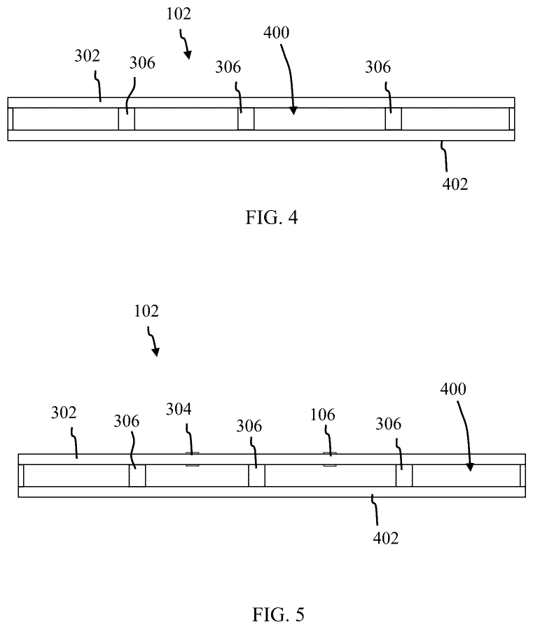

Referring now to FIG. 1-5, in a representative embodiment, an air circulation device 100 may comprise a main body 102 and a plurality of air vents 106 distributed over an upward facing surface 304 of the main body 102. The air circulation device 100 may further comprise an air coupler 108 configured to connect the air circulation device 100 to a separate air blower for providing a mass flow of air to the air coupler 108 and one or more dividers 104 configured to create separate equipment compartments. With particular reference now to FIG. 2, the main body 102 may be configured to be positioned inside of an equipment bag commonly used to store and transport sports equipment. For example, the main body 102 may comprise dimensions suitably selected to allow the main body 102 to be inserted completely into an existing gear bag such as, but not limited to, a carry or wheeled bag for hockey, baseball, lacrosse, figure skating, tennis, and the like.

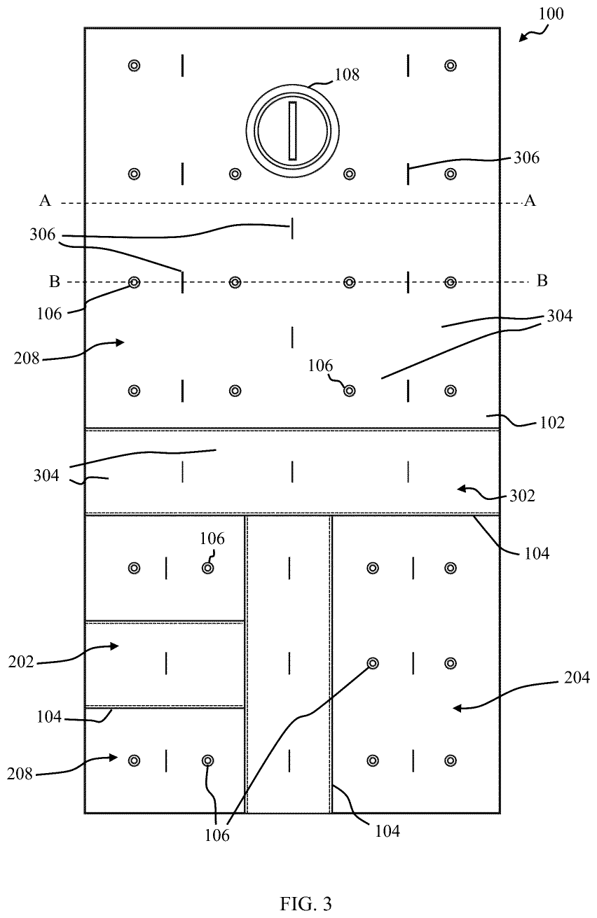

The main body 102 may comprise any suitable system or device for controllably direction a flow of air to the equipment. Referring now to FIG. 3-5, in one embodiment, the main body 102 may comprise an internal air flow chamber 400 having a set of internal baffles 306 configured to help direct the incoming air flow towards the air vents 106. The baffles 306 may comprise any suitable structure for forming one or more duct-like channels or flow paths 304. For example, in one embodiment, the baffles 306 may comprise blocks of foam secured between the upper surface 302 and a lower surface 402 of the main body 102. The upper and lower surfaces 302, 402 may be separated by a distance of between about ¼ and ¾ of an inch.

The plurality of air vents 106 may be distributed across the upper surface 302 of the main body 102. The air vents 106 may comprise any suitable device for allowing the mass flow of air to flow outwardly from the internal air flow chamber 400 of the main body 102. For example, in one embodiment the air vents 106 may comprise a series of spaced openings across the upper surface 302. The openings may be formed by a device such as a grommet located on the upper surface 302. In an alternative embodiment, the air vents 106 may comprise one or more nozzles configured to direct the air flow in a desired direction or increase the velocity of the air flow to increase drying capacity.

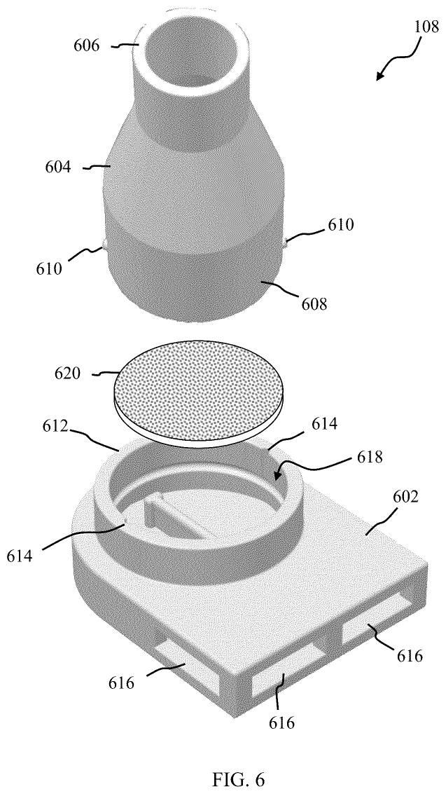

With reference now to FIGS. 1, 3 and 6, the air coupler 108 allows the main body 102 to be connected to a separate air supply system such as an air blower (not shown). The air coupler 108 may comprise any suitable device or structure for providing a selectively removable attachment location to the air blower. In one embodiment, the air coupler 108 may comprise a device configured to be connected to an end of a hose (not shown) such as commonly used with vacuums or any other type of air conduit. The air coupler 108 may also be configured to provide a low profile when not connected to the air blower. For example, the air coupler 108 may comprise a base 602 coupled to the main body 102 and a removable coupler 604.

The removable coupler 604 may have a first end 606 that is configured to be connected to a hose or other air supply device and have a second end 608 configured to be connected to the base 602. The removable coupler 604 may be configured to be connected to the base 602 by any suitable method. For example, the removable coupler 606 may comprise a pair of tabs 610 disposed along a lower surface at the second end 608 that are configured to slide into a pair of mating notches 614 disposed on a flange 612 of the base 602. The removable coupler 604 may then be locked in place by rotating the pair of tabs 610 into a locked position. In other embodiments, the removable coupler 604 may be connected to the base 602 by compression fit, a rotatable collar and sleeve, a mechanical clip, a threaded screw, or any other like method of connection.

In some embodiments, the air coupler 108 may be configured to adjust the flow rate of the incoming mass air flow or alter the pressure of the incoming air. For example, the removable coupler 604 may comprise a generally cone shape with a larger diameter at the second end 608 than that of the first end 606.

The base 602 directs the incoming air flow into the internal air flow chamber 400 of the main body 102 and may comprise any suitable device or system for directing air flow in a desired direction. For example, the base 602 may comprise one or more outlets 616 for disbursing the air flow into the main body 102. The outlets 616 may be located along one or more surfaces of the base 602 and may comprise any size or shape. The outlets 616 may also elements configured to adjust the flow of air through devices such as louvers, nozzles, diffusers, and the like.

The flange 612 may also be configured to include a filtration system. For example, the flange 612 may comprise a receiving section 618 that is configured to hold a filter 620. The filter 620 may comprise any type of filtering device or it may comprise an air freshening device. For example, the filter 620 may comprise a removable disc that contains a scent, deodorant, drying agent, or other materials which can be diffused into the passing air flow and is configured to be positioned within the flange 612.

Referring now to FIG. 1-3, once inserted into the gear bag 200, the dividers 104 may form individual sections or compartments that may be adapted to store various pieces of equipment. For example, a first compartment 202 may be configured to hold a helmet, a second compartment may 204 be configured to hold foot wear, a third compartment 206 may be configured to hold one or more gloves, and another compartment 208 may be sized to hold larger items such as a set of pads, a jersey, pants, or other similar larger or bulkier items.

The dividers 104 may also be configured to help position equipment within each compartment 202, 204, 206, 208 to help facilitate air flow over the equipment in a manner that speeds the drying process. For example, in one embodiment, the dividers may be positioned to maintain the orientation of a helmet with the main opening facing downwards towards the air vents 106.

The dividers 104 may be fixed in position or they may be configured to allow a user to create custom sized compartments based on their individual needs. The dividers 104 may also be configured to be semi-rigid so that each compartment is able to maintain a desired size or dimension relative to the main body 102. For example, the dividers 104 may comprise one or more panels having any suitable shape or size. The panels may be formed from any suitable materials such as foam, cardboard or cardstock, plastic, or composite material. Edges of the dividers 104 may comprise one or more flaps 110 or sleeves having a layer of hook and loop fastener to allow the panels to be selectively positioned relative to each other and the main body 102. For example, mating surfaces of hook and loop fastener may be positioned along various locations of the panels or main body 102 to allow for connection to the flaps 110 of the dividers 104. The flaps 110 may extend perpendicularly from the divider 104 to help orient the divider perpendicular to the upper surface 302 of the main body 102. The flaps 110 may also be used to couple a first divider 104 to a second divider 104 to help form the individual compartments or allow a user to customize the size and shape of each compartment.

The dividers 104 may comprise any suitable dimensions according to a desired type of gear bag 200. For example, and referring now to FIG. 3, in an embodiment of the present technology intended for use in a gear bag having an internal depth of fourteen inches, the dividers 104 may comprise a height of between about ten and thirteen inches. Similarly, the main body 102 may be configured to have a length and width capable of being inserted into the gear bag 200 while maintaining a substantially flat surface for the dividers 104 to be positioned perpendicular to the main body 102.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to an exemplary embodiment. However, changes and modifications may be made to the exemplary embodiment without departing from the scope of the present technology. These and other changes or modifications are intended to be included within the scope of the present technology.

1. An air circulation device for directing a flow of air from an air source through a storage container, comprising:
a main body, comprising:
an internal air flow chamber defined by an upper surface and a lower surface;
a set of internal baffles disposed within the internal air flow chamber to create one or more air flow paths; and
a plurality of air vents distributed along the upper surface of the main body, wherein the plurality of air vents are configured to allow air to flow outward from the internal air flow chamber; and
an air coupler coupled to the main body and configured to be connected to the air source to receive the flow of air and direct it into the internal air flow chamber.

2. An air circulation device according to claim 1, further comprising a set of dividers, wherein:
each divider is coupled to the upper surface of the main body and extend perpendicularly away from the upper surface; and
the set of dividers form at least two receiving compartments, wherein each compartment is open to one or more air vents.

3. An air circulation device according to claim 2, wherein the set of dividers are configured to be detachable from the upper surface.

4. An air circulation device according to claim 1, wherein the set of internal baffles extend between the upper and lower surfaces of the main body.

5. An air circulation device according to claim 1, wherein the air coupler comprises:
a base coupled to the main body; and
a removable coupler configured to connect the base to the air source.

6. An air circulation device according to claim 5, wherein the base comprises a set of outlets for directing the flow of air into the internal air flow chamber.

7. An air circulation device according to claim 5, wherein the air coupler further comprises a receiving section configured to position a filter between an inlet to the base and the set of outlets.

8. An air circulation device according to claim 5, wherein:
the removable coupler comprises a tab disposed along a lower surface;
the base comprises a mating notch disposed along a flange, wherein the notch is configured to receive the tab of the removable coupler to secure the removable coupler and base together.

9. An equipment bag air circulation device for directing a flow of air from an air source through the equipment bag, comprising:
a main body, comprising:
an internal air flow chamber defined by an upper surface and a lower surface;
a set of internal baffles disposed within the internal air flow chamber to form multiple air flow paths; and
a plurality of air vents distributed on the upper surface of the main body and along the multiple air flow paths, wherein the plurality of air vents are configured to allow air to flow outward from the internal air flow chamber and into the equipment bag; and
a set of dividers extending perpendicularly upward from the upper surface of the main body to define at least two receiving compartments within the equipment bag, wherein each compartment is open to one or more air vents;
an air coupler coupled to the main body and configured to be connected to the air source to receive the flow of air and direct it into the internal air flow chamber.

10. An equipment bag air circulation device for directing a flow of air from an air source through the equipment bag according to claim 9, wherein the air coupler comprises:
a base coupled to the main body; and
a removable coupler configured to connect the base to the air source.

11. An equipment bag air circulation device for directing a flow of air from an air source through the equipment bag according to claim 10, wherein the base comprises a set of outlets for directing the flow of air into the internal air flow chamber.

12. An equipment bag air circulation device for directing a flow of air from an air source through the equipment bag according to claim 10, wherein the air coupler further comprises a receiving section configured to position a filter between an inlet to the base and the set of outlets.

13. An equipment bag air circulation device for directing a flow of air from an air source through the equipment bag according to claim 9, wherein each divider comprises a first flap disposed along a lower edge configured to couple the divider to the upper surface of the main body.

14. An equipment bag air circulation device for directing a flow of air from an air source through the equipment bag according to claim 13, wherein a first divider comprises a second flap disposed along a side edge configured to couple the first divider to a second divider.
